(19) United States
(12) Patent Application Publication
(10) Pub. No.: US 2011/0250579 A1
(43) Pub. Date: Oct. 13, 2011

(54) DRIVEN WHEEL ENERGY AND ENTERTAINMENT DEVICE

(76) Inventors: Buddy Wakefield, Seattle, WA (US); Robert Steven Gifford, Seattle, WA (US)

(21) Appl. No.: 13/084,538

(22) Filed: Apr. 11, 2011

Related U.S. Application Data
(60) Provisional application No. 61/322,546, filed on Apr. 9, 2010.

(51) Int. Cl. G09B 23/00; G09B 23/18

(52) U.S. Cl. 434/295

(57) ABSTRACT

Disclosed is a system based on an animal habitat for the purpose of teaching and entertaining children while familiarizing them with the field of energy generation, storage, transmission, energy consumption and a complete energy cycle. The present invention combines a small animal, enclosure, exercise wheel and plants, with a generator and light source to build a complete energy cycle. Additional features benefit the child by powering a toy, electronic game or cell phone while learning how several energy transformations are used to deliver electrical power. Accessories that add supplemental wind and solar power sources also add educational opportunities for the child.

### CROSS-REFERENCE TO RELATED APPLICATIONS

This application claims U.S. Provisional Application No. 61/322,546 filed on Apr. 9, 2010.

### BACKGROUND

The present invention represents a significant step forward in the field of familiarizing children with the science of energy. Currently marketed animal habitat systems sold for the purpose of teaching and entertaining children teach in the field of animal husbandry but miss the opportunity of teaching important lessons in the field of energy generation, storage, transmission, use and a complete energy cycle. The present invention combines many of the common elements of an animal habitat such as a small animal, enclosure, exercise wheel and plants, but adds a generator and light source to build a complete energy cycle. Additional features benefit the child by powering a toy, electronic game or cell phone while learning how several energy transformations are used to deliver electrical power. Accessories that add supplemental wind and solar power sources also add educational opportunities for the child.

### PRIOR ART

The following is art representative of what is published in the field of teaching and entertainment devices in the fields of energy generation and conversion.

U.S. Pat. No. 5,135,400 to inventor Ramey discloses an educational or entertainment device that has an animal, enclosure, plants, However, the disclosure of inventor Ramey lacks an educational or entertainment device with a complete energy cycle employing an exercise wheel, generator, light source, wheel and generator mounted in the enclosure and electrical accessories mounted outside the enclosure, measurement of both wheel dynamics and power status, battery power storage and means for attaching power using and power generating devices.

U.S. Pat. No. 5,649,503 to inventor Woolfolk discloses an educational or entertainment device that has an animal, exercise wheel and a device for measurement of wheel dynamics. However, the disclosure of inventor Woolfolk lacks an educational or entertainment device with a complete energy cycle employing a generator, light source, plants, wheel and generator mounted in the enclosure and electrical accessories mounted outside the enclosure, measurement of both wheel dynamics and power status, battery power storage and means for attaching power using and power generating devices.

U.S. Pat. No. 4,389,047 to inventor Hall discloses an educational or entertainment device that has an animal, exercise wheel, generator, light source and battery power storage. However, the disclosure of inventor Hall lacks an educational or entertainment device with a complete energy cycle employing an animal enclosure with plants, wheel and generator mounted in the enclosure and electrical accessories mounted outside the enclosure, measurement of both wheel dynamics and power status, means for attaching power using and power generating devices.

U.S. Pat. No. 5,054,427 to inventor Hoover discloses an educational or entertainment device that has an animal, enclosure and exercise wheel. However, the disclosure of inventor Hoover, lacks an educational or entertainment device with a complete energy cycle employing a generator, light source, plants, wheel and generator mounted in the enclosure and electrical accessories mounted outside the enclosure, measurement of both wheel dynamics and power status, battery power storage and means for attaching power using and power generating devices.

Published Application Number US 2008/0230012 to inventor Woltman et al. discloses an educational or entertainment device that has an animal, enclosure, exercise wheel, and the wheel attached to the side of the enclosure. However, the disclosure of inventor Woltman et al. lacks an educational or entertainment device with a complete energy cycle employing a generator, light source, plants, electrical accessories mounted outside the enclosure, measurement of both wheel dynamics and power status, battery power storage and means for attaching power using and power generating devices.

### BRIEF SUMMARY OF THE INVENTION.

The present invention provides energy cycle enjoyment and education to a child. In the preferred embodiment, a small animal in an animal enclosure lives its life eating plants and exercising in a exercise wheel. The key, however, to teaching an energy cycle is the addition of an electrical generator and a light source. These two key components to the present invention close the loop and create a complete energy cycle. By understanding an energy cycle the student is learning the first law of thermodynamics which states that energy can be transformed, i.e. changed from one form to another, but cannot be created nor destroyed. This is demonstrated by the gerbil generating kinetic energy which the generator converts to electrical energy which in turn lights a light source. The plants convert the light to food and the gerbils make the energy from the food into kinetic energy.

The primary objective of the present invention is to teach the principle of an energy cycle while being entertained by an active little animal.

A further objective of the present invention is to demonstrate kinetic energy, the energy of motion, being converted to electrical energy by a wheel and generator.

A further objective of the present invention is to demonstrate electrical energy, the energy of electron motion, being converted to light energy by a light bulb.

A further objective of the present invention is to demonstrate light energy, the energy of wave motion, being converted to food by a plant.

A further objective of the present invention is to demonstrate food, or caloric energy, being converted into kinetic energy by the animal.

A further objective of the present invention is to demonstrate that motion can be measured and read from a meter or digital screen.

A further objective of the present invention is to demonstrate that electrical energy can be measured and read from a meter or digital screen.

A further objective of the present invention is to demonstrate that electricity can be stored in a battery.

A further objective of the present invention is to house the child accessible portions of the system outside of the pet enclosure.

A further objective of the present invention is to demonstrate that sound can also result from kinetic energy;

A further objective of the present invention is to improve the access to the inside of the enclosure with a hinge.

A further objective of the present invention is to incorporate a cell phone camera to provide remote monitoring of animal movements.

### BRIEF DESCRIPTION OF THE SEVERAL VIEWS OF THE DRAWING(S)

FIG. 1: Is a perspective view of the instant invention.

FIG. 2: Is a side and front view of the instant invention.

FIG. 3: Is an electrical schematic of the instant invention.

FIG. 4: Is a block diagram of the teaching aspects of the instant invention.

### DETAILED DESCRIPTION OF THE INVENTION

The preferred embodiment of the present invention is sized for a gerbil pet that is confined in a cage or transparent enclosure. However, it is considered within the scope of the present invention to facilitate animals of any size. It is also considered within the spirit of the invention to replace the device support provided by the cage or enclosure with an alternate support structure which is known to one of ordinary skill. It is further considered within the scope of the present invention that any suitable animal enclosure may take the place of the cage of the preferred embodiment.

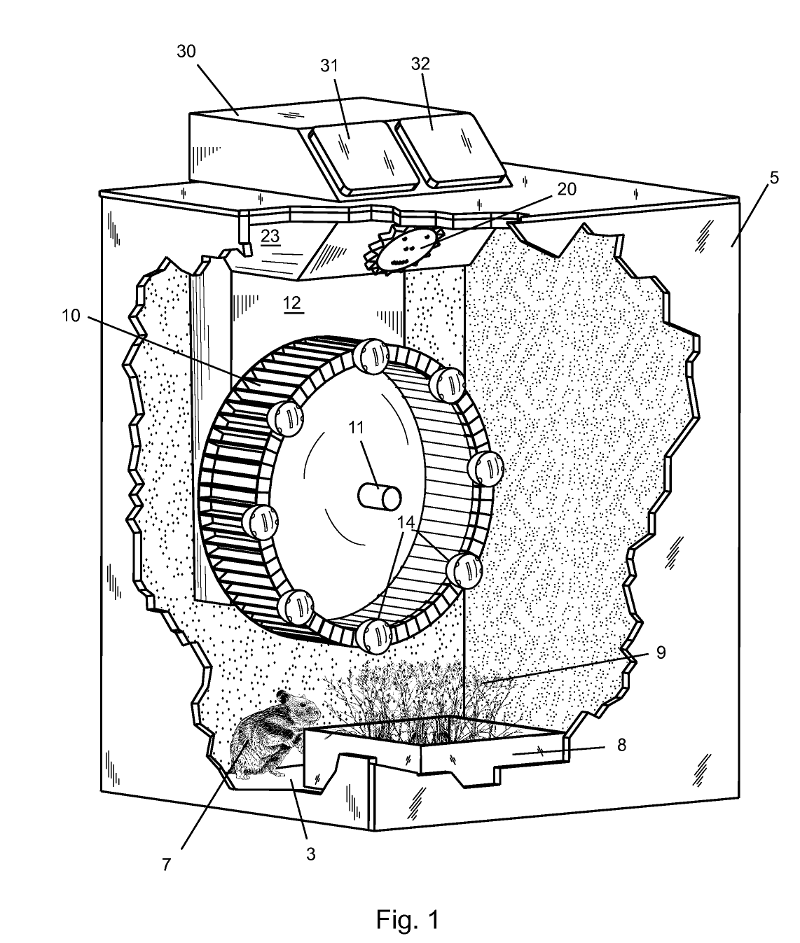

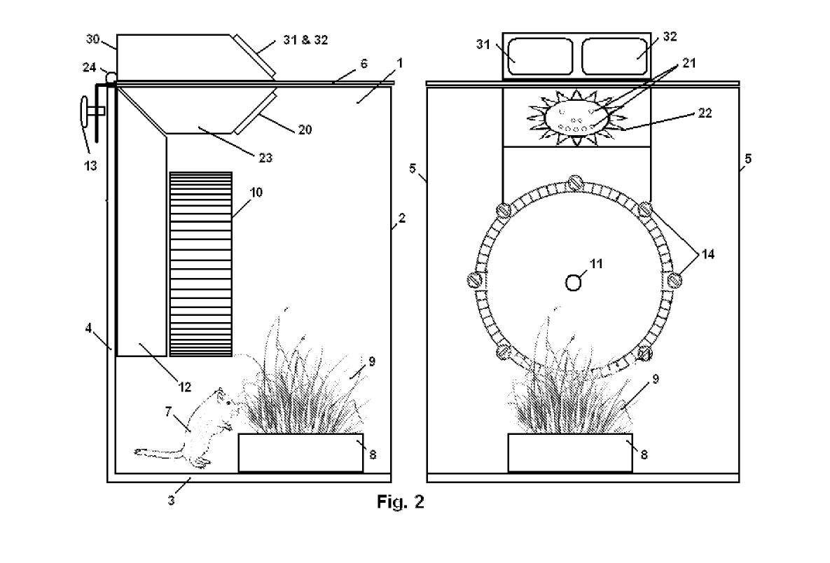

FIGS. 1 and 2 show an animal cage 1, the cage 1 has a front panel 2, a base panel 3 a back panel 4, two side panels 5 and a cover 6 that rests on the front panel 2, back panel 4 and side panels 5 of cage 1. The animal 7 is free to roam about the cage 1 which includes garden box 8 and plants 9. An exercise wheel 10 rotates shaft 11 and shaft 11 in turn is supported by first enclosure 12 which in turn is fastened to the back panel 4 of the cage 1 with a clamp 13. One or more bells 14 make sound while the the exercise wheel 10 rotates.

Light source 20 comprises one or more lights 21 with a surround 22 in a shape representing the sun. Light source 20 is supported by the third enclosure 23. Third enclosure also has a mounting for a separate video camera or for a cell phone with a video camera (un-shown) for monitoring the movement of the animal and the remaining animal food. It is considered to be within the skill of one of ordinary skill to design these brackets as there is no standard design for hand held electronic devices. Third enclosure 23 is fastened to first enclosure 12 and clamp 13 by hinge 24. Cover 6 is subsequently attached to third enclosure 23 so that third enclosure 23 and cover 6 swing upward around hinge 24 when cover 6 is lifted for access to the inside of cage 1.

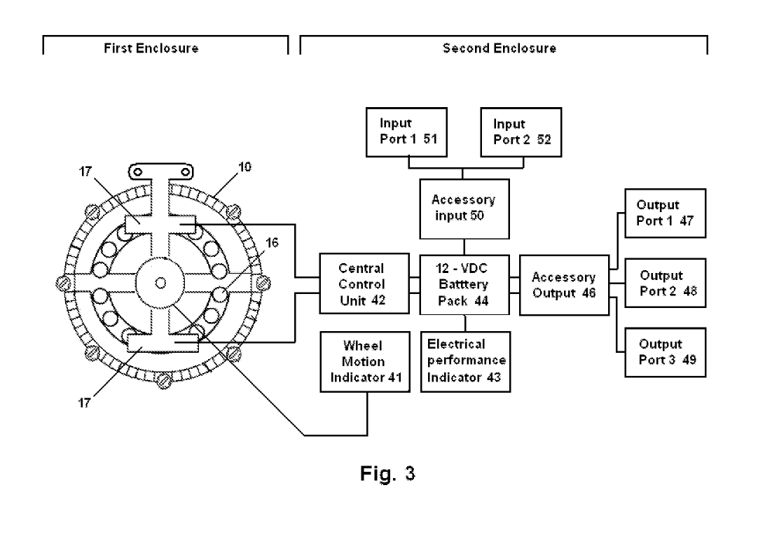

Second Enclosure 30 is fastened to the cover 6. A wheel motion indicator 41 can take the form of a speedometer, odometer or revolution counter or multiple forms. An electrical performance indicator 43 monitors the electrical performance of the present invention which can include the quantity of power being generated, battery charge status or total system output. Also located in the second enclosure 30 are the central control unit 42, battery pack 44 and accessory outputs 46 which are further explained in the following paragraph regarding FIG. 3.

FIG. 3 shows an electrical diagram of the present invention. The exercise wheel 10 rotates the permanent magnets 16 producing electrical flux in the stator coils 17. The central control unit 42 accumulates the power from the stator coils 17 and intermittently outputs the power at a set voltage which in this case is 13.1 to 13.5 VDC. The central control unit is a purchased item from Sullivan Products model number S660-12V. Any equivalent device may be used. The power is then stored in the battery 44. The battery 44 is a 12 volt storage cell for prototyping we used a Power Sonic Model PS-1212. Any equivalent device may be used. The input ports 51 and 52 used to accept power from other sources such as Solar cells or a small wind turbine connect directly to the battery pack 44. The output ports 47, 48 and 49 also connect directly to the battery pack 44 the light source 21 is one such accessory.

The Electrical Performance indicator 43 used for prototyping is a Model Euro Factory#VP7901 Part#12823, made by Faria. The wheel motion detector and indicator used in prototyping are a Model CC-RD100 CY1149 made by Cat Eye.

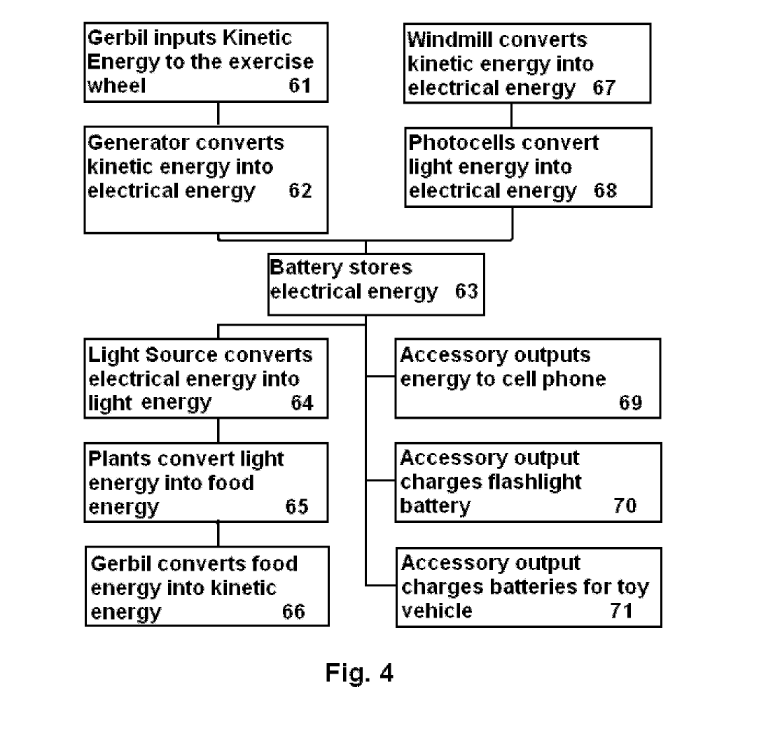

The block diagram of FIG. 4 summarizes the principles that are being taught to a child through the present invention. The gerbil inputs kinetic energy into the exercise wheel at 61, the generator makes the kinetic energy into electrical power at 62, the battery stores the electrical power at 63, The light source makes the electrical power into light at 64, the Plant makes the light into food at 65, the gerbil makes the food into kinetic energy at 66. Accessory inputs from a windmill at 67 and photocells at 68 add to the power stored in the battery 63. Accessory outputs power cell phones at 69, flashlight batteries at 70 and batteries for moving toys at 71.

Although the terms and definitions used in the specification are intended to be read into the claims they are hot intended to limit the meets and bounds of the claims presented here below in any manner whatsoever.

I claim:

1. An energy cycle education and entertainment device, comprising:
an animal;
an animal exercise device;
an electrical generator;
a light source;
one or more plants;
wherein the animal moves a part of the exercise device while exercising;
wherein the part of the exercise device moves the armature of the electrical generator;
wherein the electric generator supplies power to the light source;
wherein the light source supplies light to the one or more plants;
wherein the one or more plants supply a food source to the animal.

2. The energy cycle education and entertainment device of claim 1, further comprising:
a rechargeable battery for storing the output of the electrical generator.

3. The energy cycle education and entertainment device of claim 1, further comprising:
a system electrical performance indicator.

4. The energy cycle education and entertainment device of claim 1, further comprising:
an animal exercise device motion indicator.

5. The energy cycle education and entertainment device of claim 1, further comprising:
one or more ports to distribute electricity to external devices.

6. The energy cycle education and entertainment device of claim 1, further comprising:
one or more ports that receive energy form external power sources.

7. The energy cycle education and entertainment device of claim 1, wherein:
the light source is in the form of a symbol of the sun.

8. The energy cycle education and entertainment device of claim 1, further comprising:
an external power source that derives energy from the sun.

9. The energy cycle education and entertainment device of claim 1, further comprising:
an external power source that derives energy from the wind.

10. The energy cycle education and entertainment device of claim 1, further comprising:
an animal enclosure.

11. The energy cycle education and entertainment device of claim 1, wherein:
the animal exercise device and electrical generator are supported by a first housing attached to a wall of the animal enclosure.

12. The energy cycle education and entertainment device of claim 1, further comprising:
a second housing for the battery charge indicator and animal exercise device motion indicator external to the enclosure.

13. The energy cycle education and entertainment device of claim 1, further comprising:
a flexible connection between the first housing and the second housing.

14. The energy cycle education and entertainment device of claim 1, further comprising:
a hinge connecting the first housing with the second housing.

15. The energy cycle education and entertainment device of claim 1, further comprising:
a mounting for a cell phone with the animal in the camera field of view.

16. The energy cycle education and entertainment device of claim 1, further comprising:
a sound generator for making sound while the animal exercise device turns.

17. The energy cycle education and entertainment device of claim 1, further comprising:
One or more bells attached to the animal exercise device for making sound while the exercise device turns.
